(19) United States
(12) Patent Application Publication
(10) Pub. No.: US 2021/0087020 A1
(43) Pub. Date: Mar. 25, 2021

(54) ELEVATOR CAR FRAME

(71) Applicant: Otis Elevator Company, Farmington, CT (US)

(72) Inventors: Jean-Emile Rocher, Lorris (FR); Vincent Lopez, Gien (FR)

(21) Appl. No.: 16/835,737

(22) Filed: Mar. 31, 2020

(30) Foreign Application Priority Data
Sep. 19, 2019 (EP) 19306131.4

(51) Int. Cl. B66B 11/02; B66B 19/00

(52) U.S. Cl. CPC B66B 11/0206; B66B 19/00; B66B 11/0226

(57) ABSTRACT

Foldable elevator car frame (20) comprising a ceiling (34), a floor platform (36) and at least one upright (24) extending between the floor platform (36) and the ceiling (34). The foldable elevator car frame (20) further comprises at least one hinge (35) allowing at least a movable portion (36b) of the floor platform (36) and/or a movable portion (34b) of the ceiling (34) to pivot with respect to the at least one upright (24) between a folded transportation configuration and an extended operational configuration.

### FOREIGN PRIORITY

This application claims priority to European Patent Application No. 19306131.4, filed Sep. 19, 2019, and all the benefits accruing therefrom under 35 U.S.C. § 119, the contents of which in its entirety are herein incorporated by reference.

### BACKGROUND

The invention relates to an elevator car frame, to an elevator car comprising such an elevator car frame, and to an elevator system with at least one elevator car. The method further relates to a method of installing an elevator car within a hoistway of an elevator system.

An elevator system as referred to herein typically comprises at least one elevator car moving along a hoistway extending between a plurality of landings, and a driving member (tension member) configured for driving the elevator car. In particular embodiments, the elevator system may further include a counterweight moving concurrently and in opposite direction with respect to the elevator car.

As spatial access to the hoistway is restricted, the elevator car needs to be assembled from individual components within the hoistway. Installing the elevator car within the hoistway is cumbersome, costly, and time-consuming

It would be beneficial to facilitate the assembly of an elevator car, in particular the assembly within the hoistway of an elevator system.

### SUMMARY

According to an exemplary embodiment of the invention, a foldable elevator car frame comprises a floor platform, a ceiling and at least one upright extending between the floor platform and the ceiling. The foldable elevator car frame further comprises at least one hinge which allows at least a portion of the floor platform and/or a portion of the ceiling to pivot with respect to the at least one upright between a folded transportation configuration and an extended operational configuration.

Exemplary embodiments of the invention also include an elevator car comprising a foldable elevator car frame according to an exemplary embodiment of the invention and at least one side panel extending between the ceiling and the floor platform respectively arranged in the extended operational configurations.

Exemplary embodiments of the invention further include an elevator system comprising at least one hoistway extending between a plurality of landings and at least one elevator car according to an exemplary embodiment of the invention which is movably suspended in the at least one hoistway in a configuration allowing the elevator car to move along the hoistway between the plurality of landings.

Exemplary embodiments of the invention also include a method comprising the steps of arranging the foldable elevator car frame, in which the movable portions are arranged in their respective folded transportation configurations, within the hoistway; unfolding the movable portions into their extended operational configurations; and fixing the movable portions in their respective extended operational configurations.

A foldable elevator car frame according to an exemplary embodiment according to an exemplary embodiment may be introduced into the hoistway of an elevator system through a relatively small opening, such as an opening of a landing door or an opening of a service door providing access to the hoistway.

Thus, the elevator car frame may be pre-assembled in the factory, brought into its folded transportation configuration, introduced into the hoistway through an existing opening and then unfolded into its extended operational configuration. As a result, the installation of the elevator car at the site of the elevator system is considerably facilitated and speeded-up, and the costs for the installation are reduced.

A number of optional features are set out in the following. These features may be realized in particular embodiments, alone or in combination with any of the other features, unless specified otherwise.

The at least one movable portion of the floor platform and/or the at least one portion of the ceiling may be pivotable around a respective axis which is oriented orthogonally to the at least one upright. This allows moving the at least one movable portion into a very space-saving folded transportation configuration.

The foldable elevator car frame may further comprise at least one fixing mechanism which is configured for fixing the at least one movable portion when arranged in the folded transportation configuration and/or in the extended operational configuration. This avoids the at least one pivotable portion from undesirably pivoting between the folded transportation configuration and in the extended operational configuration.

The at least one fixing mechanism may include at least one of a bolt, a screw and a hole for providing a simple but reliable fixing mechanism.

The floor platform and/or the ceiling may comprise a rigid portion which is rigidly connected to the at least one upright, and at least one pivotable portion which is pivotably connected to the rigid portion by the at least one hinge. This provides a very stable connection between the platform and/or the ceiling and the at least one upright. The rigid portion in particular may be welded to or formed integrally with the at least one upright.

The foldable elevator car frame may further include at least one side panel, which is pivotably mounted to the at least one upright. The at least one side panel in particular may be pivotable around an axis which is oriented parallel to the at least one upright. A foldable elevator car frame comprising at least one side panel allows installing the side walls of the elevator car easily by pivoting the side panels into their extended operational configurations.

In an embodiment, the at least one upright comprises an upper portion pivotably connected to the ceiling; a lower portion pivotably connected to the floor platform; and a middle portion pivotably connected to the upper and lower portions, respectively. In such an embodiment, the at least one upright is foldable between an extended operational configuration, in which the upper portion, the middle portion, and the lower portion extend linearly along a common axis; and a folded transportation configuration, in which the upper and lower portions are oriented in an inclined configuration with respect to the middle portion.

In such an embodiment, the elevator car frame is very compact when arranged in the folded transportation configuration. In this configuration the dimensions of the elevator car frame in particular are defined by the dimensions, in particular the footprint, of the ceiling and/or of the floor platform.

When such an embodiment is employed, a method of installing an elevator car within a hoistway may include unfolding the at least one upright into an unfolded configuration in which it extends orthogonally to the floor platform and orthogonally to the ceiling.

At least one of the upper and lower portions of at least one of the uprights may be configured for supporting at least one functional component, such as a safety, at least one guiding element, such as a guide shoe, and/or at least one sensor, in particular a sensor configured for detecting the position, the velocity and/or the acceleration of the elevator car frame.

In an exemplary embodiment, at least one functional component, such as a safety, at least one guiding element, and/or at least one sensor, in particular a sensor configured for detecting the position, the velocity and/or the acceleration of the elevator car frame, may be arranged in at least one of the upper and lower portions of at least one of the uprights.

For connecting at least one driving member to the foldable elevator car frame, the foldable elevator car frame may further comprise at least one fixing portion, which is configured for connecting at least one driving member with the elevator car. Said fixing portion may include and/or support at least one driving member guide element, e.g. a pulley, which is configured for guiding a driving member supporting and driving the elevator car. Depending on the configuration of the elevator system, the at least one fixing portion may be arranged above the ceiling and/or below the floor platform of the elevator car.

### DRAWING DESCRIPTION

In the following, exemplary embodiments of the invention are described in more detail with respect to the enclosed figures:

FIG. 1 schematically depicts an elevator system with an elevator safety device according to an exemplary embodiment of the invention.

FIG. 2 shows a perspective view of an elevator car frame according to an exemplary embodiment of the invention in an extended operational configuration.

FIG. 3 shows a perspective view of the elevator car frame depicted in FIG. 2 in a folded transportation configuration.

FIG. 4 shows a side view of the elevator car frame depicted in FIG. 3.

FIGS. 5 and 6 show enlarged details of an upper portion of the elevator car frame depicted in FIGS. 2 to 4 in the folded transportation configuration.

FIG. 7 is a perspective view of the elevator car frame according to another exemplary embodiment of the invention in a folded transportation configuration.

FIG. 8 shows a side view of an elevator car frame depicted in FIG. 7.

FIG. 9 shows a side view the elevator car frame depicted in FIGS. 7 and 8 in an extended operational configuration.

FIG. 10 is a perspective view of the elevator car frame depicted in FIG. 9.

FIG. 11 shows a perspective view of an elevator car comprising an elevator car frame according to the embodiment depicted in FIGS. 7 to 10.

### DETAILED DESCRIPTION

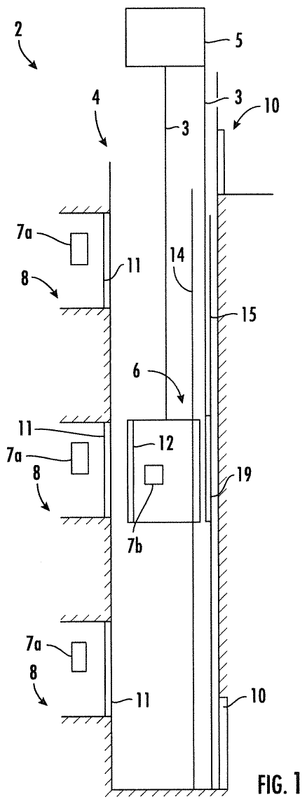

FIG. 1 schematically depicts an elevator system 2 according to an exemplary embodiment of the invention.

The elevator system 2 includes an elevator car 6 movably arranged within a hoistway 4 extending between a plurality of landings 8. The elevator car 6 in particular is movable in a longitudinal (vertical) direction along a plurality of car guide members 14, such as guide rails, extending along the vertical direction of the hoistway 4. Only one of said car guide members 14 is depicted in FIG. 1.

Although only one elevator car 6 is shown in FIG. 1, the skilled person understands that exemplary embodiments of the invention may include elevator systems 2 including a plurality of elevator cars 6 moving in one or more hoistways 4.

The elevator car 6 is movably suspended by means of a driving member (tension member) 3. The driving member 3, for example a rope or belt, is connected to a drive unit 5, which is configured for driving the driving member 3 in order to move the elevator car 6 along the height of the hoistway 4 between the plurality of landings 8, which are located on different floors.

Details of the roping configuration are not specified in FIG. 1. The skilled person understands that the type of the roping is not essential for the invention and that different kinds of roping, such as a 1:1 roping, a 2:1 roping or a 4:1 roping may be employed.

The driving member 3 may be a rope, e.g. a steel wire rope, or a belt. The driving member 3 may be uncoated or may have a coating, e.g. in the form of a polymer jacket. In a particular embodiment, the driving member 3 may be a belt comprising a plurality of polymer coated steel cords (not shown). The elevator system 2 may have a traction drive including a traction sheave for driving the driving member 3. In an alternative configuration, which is not shown in the figures, the elevator system 2 may be an elevator system 2 without a driving member 3.

The elevator system 2 also may comprise e.g. a hydraulic drive or a linear drive. The elevator system 2 may have a machine room (not shown) or it may be a machine room-less elevator system 2.

The elevator system 2 further includes a counterweight 19 attached to the driving member 3 and configured for moving concurrently and in opposite direction with respect to the elevator car 6 along at least one counterweight guide member 15. The skilled person will understand that the invention may be applied also to elevator systems 2 which do not comprise a counterweight 19.

Each landing 8 is provided with a landing door 11, and the elevator car 6 is provided with a corresponding elevator car door 12 for allowing passengers to transfer between a landing 8 and the interior of the elevator car 6 when the elevator car 6 is positioned at the respective landing 8.

At least one service door 10 may provide access to the hoistway 4.

The drive unit 5 is controlled by an elevator control unit (not shown) for moving the elevator car 6 along the hoistway 4 between the different landings 8.

Input to the elevator control unit may be provided via landing control panels 7a, which are provided on each landing 8 close to the landing doors 11, and/or via an elevator car control panel 7b, which is provided inside the elevator car 6.

The landing control panels 7a and the elevator car control panel 7b may be connected to the elevator control unit by means of electric wires, which are not shown in FIG. 1, in particular by an electric bus, or by means of wireless data connections.

When installing the elevator system 2, at least one elevator car 6 needs to be installed within the hoistway 4. Usually the hoistway may be accessed only via the landing doors 11 and/or the service doors 10. Thus, spatial access to the hoistway 4 is limited. In consequence, it is impossible to completely assemble the elevator car 6 outside the hoistway 4 and introduce the assembled elevator car 6 into the hoistway 4. Instead, individual components of the elevator car 6 need to be brought into the hoistway 4 in order to assemble the elevator car 6 within the hoistway 4. As a result, the installation of the elevator car 6 is cumbersome, costly, and time-consuming.

For facilitating the installation of elevator cars 6, the present invention proposes to provide a foldable elevator car frame 20, in particular a foldable elevator car frame 20 which is foldable between at least one extended operational configuration and at least one folded transportation configuration, which allows introducing the elevator car frame 20 into the hoistway 4 even through relatively small and narrow openings, such as landing doors 11 and/or service doors 10.

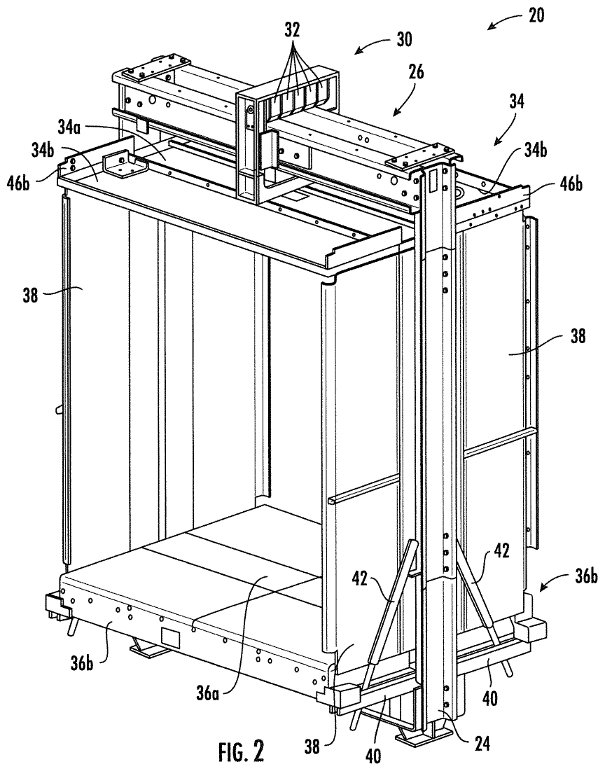

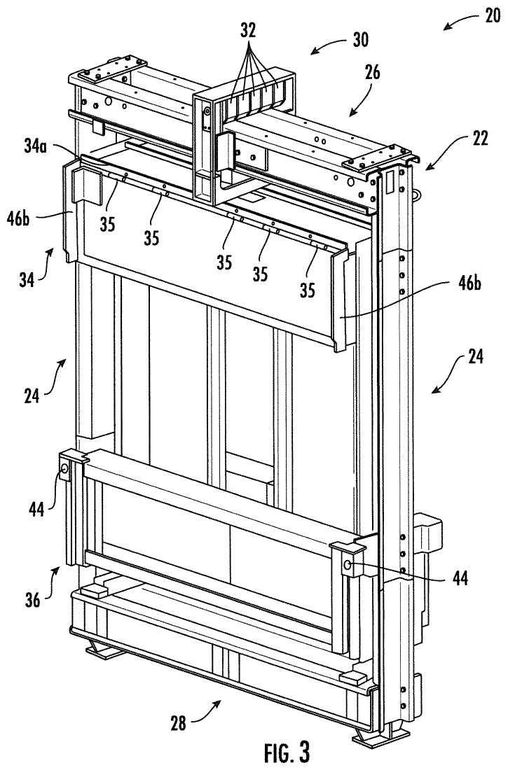

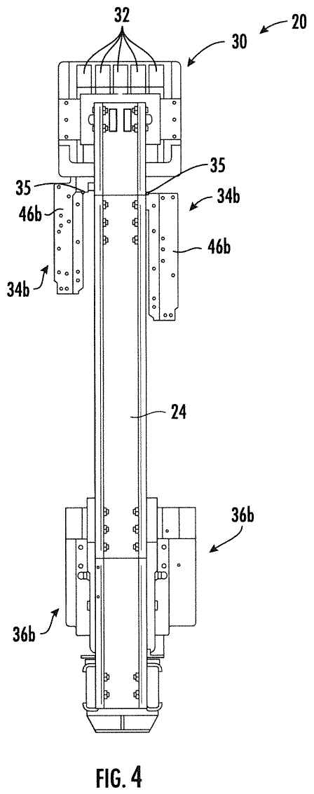

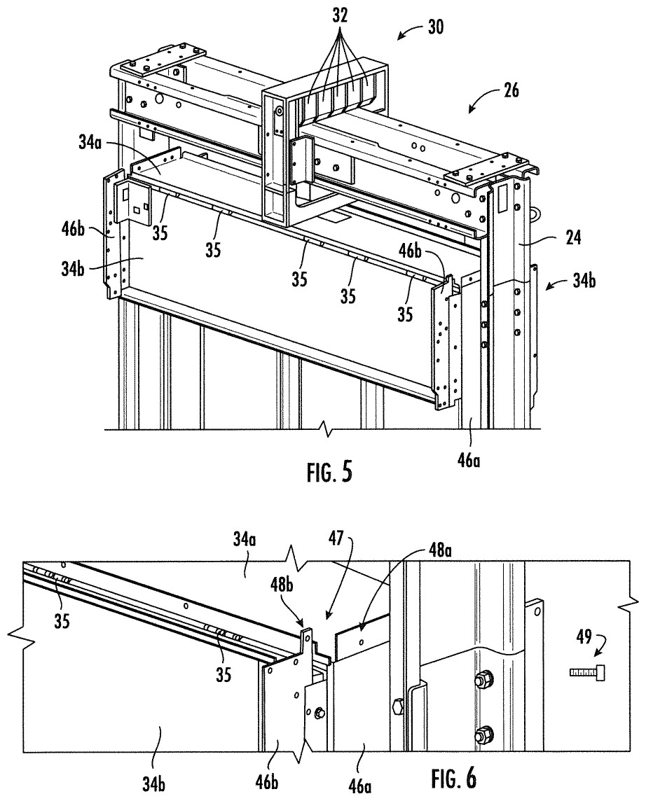

FIG. 2 shows a perspective view of an elevator car frame 20 according to an exemplary embodiment of the invention in an extended operational configuration. FIG. 3 shows a perspective view of the elevator car frame 20 in the folded transportation configuration, and FIG. 4 shows a side view thereof. FIGS. 5 and 6 show enlarged details of an upper portion of the elevator car frame 20 depicted in FIGS. 2 to 4 in the folded transportation configuration.

The elevator car frame 20 depicted in FIGS. 2 to 6 comprises a support frame 22 including an upper support bar 26, a lower support bar 28 extending basically parallel to the upper support bar 26, and two uprights 24 extending orthogonally to the upper and lower support bars 26, 28 between the upper support bar 26 and the lower support bar 28 forming a rectangular support frame 22. Usually, the upper and lower support bars 26, 28 extend basically horizontally, and the uprights 24 extend basically vertically.

A driving member mounting frame, which acts a fixing portion 30 and supports a plurality of driving member guide elements 32, which may include pulleys, is elastically mounted to the upper support bar 26. When the elevator car 6 is installed within the hoistway 4, the driving member 3 (cf. FIG. 1) extends along the driving member guide elements 32 for supporting and moving the elevator car 6.

In an alternative configuration the fixing portion 30 may be arranged below the floor platform 36.

In another alternative configuration, which is not explicitly depicted in the figures, at least one driving member 3 may be attached directly to the fixing portion 30.

A ceiling 34 and a floor platform 36 are mounted to the support frame 22, in particular to the uprights 24 of the support frame 22.

The ceiling 34 comprises a stationary (central) portion 34a, which is rigidly, i.e. non-pivotably, mounted to the support frame 22, in particular to the uprights 24 of the support frame 22. The stationary portion 34a of the ceiling 34 in particular extends basically horizontally, and parallel to the upper support bar 26, between the uprights 24.

The ceiling 34 further comprises two movable portions 34b, which are pivotably mounted to opposite sides of the stationary portion 34a by means of hinges 35 (see FIG. 6).

The movable portions 34b are pivotable between a folded transportation configuration (see FIGS. 3 to 6), in which the movable portions 34b extend basically parallel to the uprights 24 in a basically vertical direction, and an extended operational configuration, in which the movable portions 34b extend basically orthogonally to the uprights 24 in a basically horizontal direction (see FIG. 2).

The floor platform 36 comprises a stationary (central) portion 36a, which is rigidly, i.e. non-pivotably, mounted to the support frame 22, in particular to the uprights 24 of the support frame 22. The stationary portion 36a of the floor platform 36 in particular extends basically horizontally, and parallel to the lower support bar 28, between the uprights 24.

The floor platform 36 further comprises two movable portions 36b, which are pivotably mounted to opposite sides of the stationary portion 34a by means of hinges, which are not visible in the figures.

The movable portions 36b in particular are pivotable between a folded transportation configuration (see FIGS. 3 to 6), in which the movable portions 36b extend basically parallel to the uprights 24 in a basically vertical direction, and an extended operational configuration, in which the movable portions 36b extend basically orthogonally to the uprights 24 in a basically horizontal direction (see FIG. 2).

Although the ceiling 34 and the floor platform 36 are depicted with two movable portions 34b, 36b, respectively, the skilled person understands, that a foldable elevator car frame 20 according to exemplary embodiments of the invention may comprise less, in particular one, or more movable portions 34b, 36b of the ceiling 34 and/or of the floor platform 36, respectively.

The elevator car frame 20 further comprises foldable support elements 40, which are pivotably mounted to the uprights 24 at positions below the floor platform 36. Similar to the movable portions 36b of the floor platform 36, the foldable support elements 40 are movable between a folded transportation configuration (see FIGS. 3 to 6), in which the foldable support elements 40 extend basically parallel to the uprights 24 in a basically vertical direction, and an extended operational configuration (see FIG. 2), in which the foldable support elements 40 extend basically orthogonally to the uprights 24 in a basically horizontal direction. When the support elements 40 and the movable portions 36b are arranged in their respective extended operational configurations, the support elements 40 support the movable portions 36b of the floor platform 36 (see FIG. 2).

For providing additional support, support rods 42 respectively extending in a diagonal direction between the foldable support elements 40 and one of the uprights 24 may be installed, when the movable portions 36b of the floor platform 36 and the foldable support elements 40 are arranged in the extended operational configuration.

Optionally, elastic buffers 44 are provided at the bottom of the movable portions 36b of the floor platform 36. When the movable portions 36b of the floor platform 36 and the foldable support elements 40 are arranged in their respective extended configurations, the elastic buffers 44 are arranged between the movable portions 36b of the floor platform 36 and the foldable support elements 40, thereby reducing the transfer of vibrations between the movable portions 36b of the floor platform 36 and the foldable support elements 40.

The elevator car frame 20 further comprises one or more, in particular four, movable side panels 38. Each of the side panels 38 is pivotable between a retracted transportation configuration (see FIGS. 3 to 6) and an extended operational configuration (see FIG. 2). Each of the side panels 38 is pivotable around a basically vertical axis extending basically parallel to uprights 24.

When arranged in the retracted transportation configuration, the side panels 38 basically extend within a plane defined by the support frame 22, i.e. orthogonally to the plane of FIG. 4. In this configuration, the side panels 38 do not contribute to the thickness of the elevator car frame 20.

As a result, when arranged in the folded transportation configuration, the elevator car frame 20 may be introduced more easily into a hoistway 4 even through relatively small openings, such as the openings of landing doors 11 and/or the openings of service doors 10.

When arranged in their respective extending operational configurations, the side panels 38 form side walls of the elevator car 6 (cf. FIG. 2). When arranged in their respective extending operational configurations, the side panels 38 may further support the movable portions 34b of the ceiling 34, preventing said movable portions 34b from moving, in particular dropping, back into their respective folded transportation configuration.

Additionally, at least one fixing mechanism 47, which is configured for preventing the movable portions 34b, 36b from moving between their respective extended and folded configurations, may be provided. An example of such a fixing mechanism 47 is depicted in FIG. 6.

For providing the fixing mechanism 47, the stationary portion 34a and the movable portions 34b of the ceiling 34 are formed with a rim 46a, 46b extending from the respective portion 34a, 34b, respectively. The rims 46a, 46b in particular may extend basically orthogonally from the respective portions 34a, 34b.

At least one opening 48a, 48b is formed in each of said rims 46a, 46b. The positions of the openings 48a, 48b are set so that the openings 48a, 48b are aligned coaxially with each other when the respective movable portion 34b is arranged in its extended operational configuration and/or in its retracted transportation configuration. A fixing element 49, such as a bolt or a screw, is passed through the coaxially aligned openings 48a, 48b for preventing any movement of the respective movable portion 34b with respect to the stationary portion 34a.

Although a fixing mechanism 47 is depicted only for the ceiling 34 in FIG. 6, the skilled person understands that the movable portions 36b of the floor platform 36 may be provided with a similar fixing mechanism 47, too.

Other types of fixing mechanisms, which are known in the art and which are not explicitly shown on the figures, such as snap-on and/or clamping mechanisms, may be employed as well.

Alternatively, the movable portions 34b, 36b may be soldered or welded after being moved into their respective extended operational configuration. Soldering or welding the movable portions 34b, 36b to the stationary portions 34a, 36a results in a very rigid and stable configuration of the elevator car frame 20.

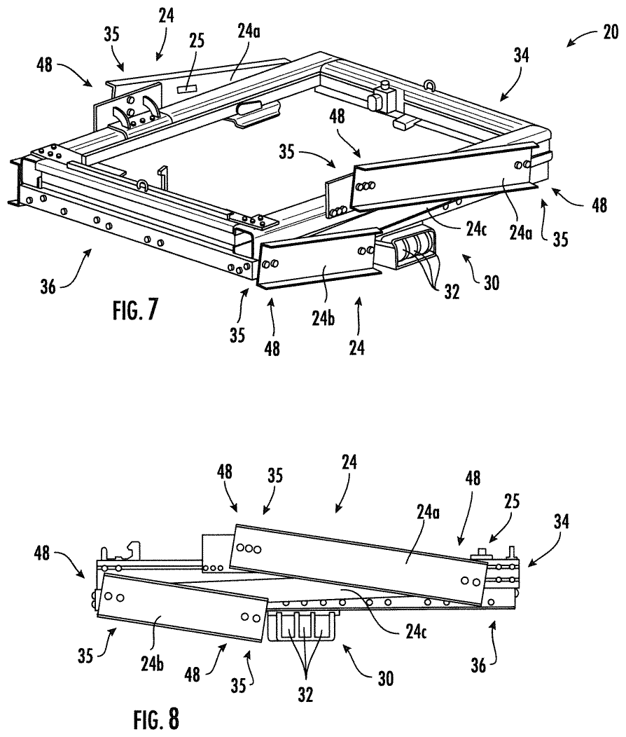

FIGS. 7 to 11 depict an elevator car frame 20 according to another exemplary embodiment of the invention.

FIG. 7 is a perspective view of the elevator car frame 20 in a folded transportation configuration, and FIG. 8 is a side view thereof.

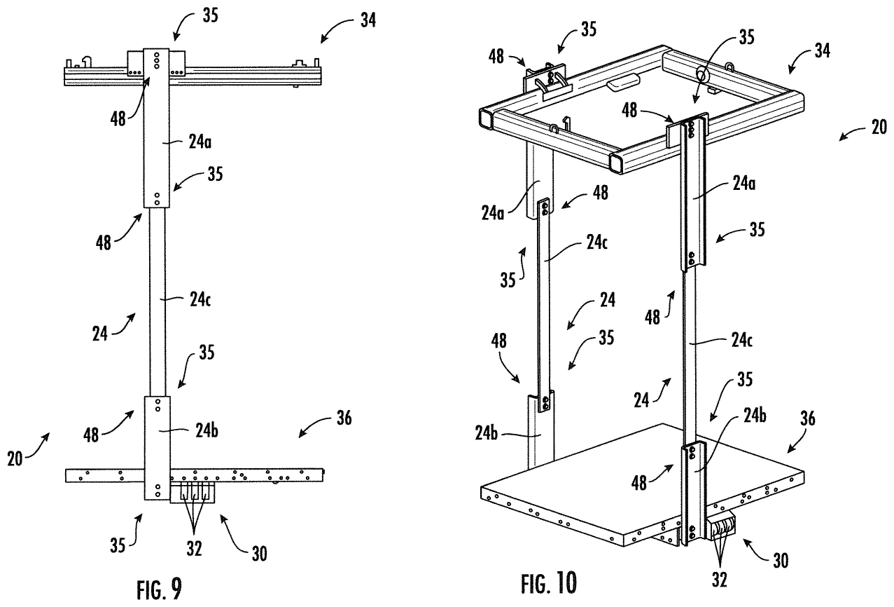

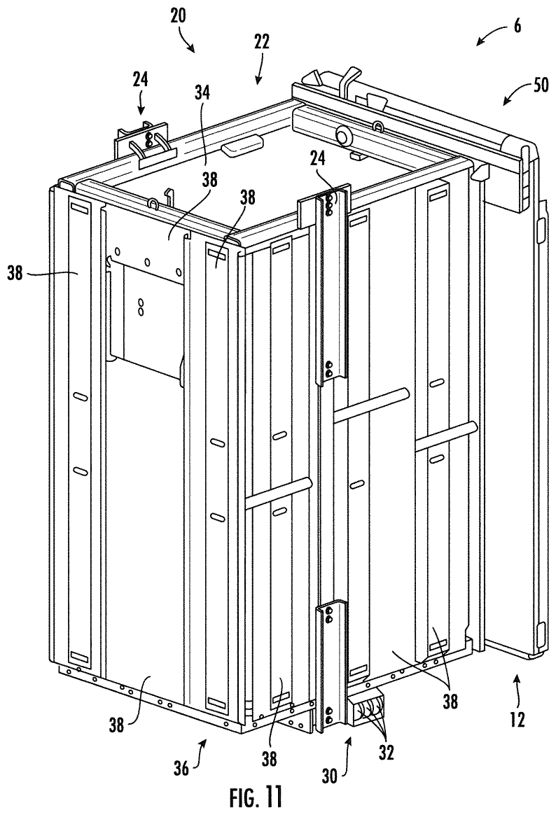

FIG. 9 shows a side view of the elevator car frame 20 depicted in FIGS. 7 and 8 in an extended operational configuration, and FIG. 10 is a perspective view thereof.

Similar to the embodiment depicted in FIGS. 2 to 6, the elevator car frame 20 comprises a floor platform 36 and a ceiling 34 connected with each other by two uprights 24. One upright 24 is arranged on each lateral side of the elevator car frame 20, respectively.

Each upright 24 comprises an upper portion 24a, which is pivotably connected to the ceiling 34, and a lower portion 24b, which is pivotably connected to the floor platform 36. Each upright 24 further comprises a middle portion 24c, which is pivotably connected to both, the upper portion 24a and the lower portion 24b of the respective upright 24.

As a result, each upright 24 is foldable between a folded transportation configuration (see FIGS. 7 and 8), in which the upper and lower portions 24a, 24b of the uprights 24 are oriented in an inclined configuration with respect to the middle portion 24c, respectively. The folded transportation configuration allows arranging the ceiling 34 right on top of the floor platform 36, as depicted in FIGS. 7 and 8. This results in a very compact, space-saving configuration of the elevator car frame 20.

When arranged in the folded transportation configuration, the elevator car frame 20 may be introduced into the hoistway 4 even through relatively small openings, such as the openings provided by the landing doors 11 and/or the service doors 10.

After being introduced into the hoistway 4, the elevator car frame 20 may be unfolded from the folded transportation configuration depicted in FIGS. 7 and 8 into the extended operational configuration depicted in FIGS. 9 and 10 by lifting the ceiling 34 upwards away from the floor platform 36.

Hinges 35 connecting the upper portions 24a with the ceiling 34 allow the upper portions 24a to pivot with respect to the ceiling 34. Hinges 35 connecting the lower portions 24b with the floor platform 36 allow the lower portions 24b to pivot with respect to the floor platform 36.

Additional hinges 35 provided between the upper and lower portions 24a, 24b and the middle portion 24c of the uprights 24 allow the uprights 24 to unfold into an extended operational configuration, as depicted in FIGS. 9 and 10.

The hinges 35 may be formed by connecting two adjacent parts only with a single bolt or a single untightened screw, allowing the two parts to pivot with respect to each other.

In the extended operational configuration, the upper portion 24a, the middle portion 24c, and the lower portion 24b of the respective upright 24 extend basically linearly along a common vertical axis which is oriented orthogonally to the basically horizontally extending ceiling 34 and floor platform 36.

The upper portion 24a, the middle portion 24c, and the lower portion 24b may be fixed in said extended configuration by fixing mechanisms 47, which may be implemented similar to the fixing mechanism 47 depicted in FIG. 6. I.e. the fixing mechanisms may include openings 48a, 48b formed in adjacent pivotable elements 24a, 24b, 24c, 34, 36 and fixing elements 49 (cf. FIG. 6), such as bolts or screws, preventing the adjacent pivotable elements 24a, 24b, 24c, 34, 36 from pivoting with respect to each other when the fixing element are introduced into the openings 48a, 48b.

Other kinds of fixing mechanisms, which are known in the art and which are not explicitly shown on the figures, such as snap-on and/or clamping mechanisms may be employed as well.

Alternatively, the pivotable elements 24a, 24b, 24c, the ceiling 34, and the floor platform 36 may be soldered or welded to each other when arranged in the extend operational configuration. Soldering or welding results in a very rigid and stable configuration of the elevator car frame 20.

At least one functional component 25 (see FIG. 7), such as a safety, at least one guiding element, and/or at least one sensor, in particular a sensor configured for detecting the position, the velocity and/or the acceleration of the elevator car frame, may be arranged in at least one of the upper and lower portions 24a, 24b of at least one of the uprights 24.

In the embodiment depicted in FIGS. 7 to 10, the fixing portion 30 with the driving member guide elements 32 configured for guiding the driving element 3 are arranged below the floor platform 36. In an alternative configuration, which is not explicitly shown in the figures, the driving member guide elements 32 may be arranged on top of the elevator car frame 20, similar to the configuration depicted in FIGS. 2 to 6.

FIG. 11 shows a perspective view of an elevator car 6 comprising an elevator car frame 20 according to the embodiment depicted in FIGS. 7 to 10.

After the elevator car frame 20 has been brought into the extended operational configuration (cf. FIGS. 9 and 10), side panels 38 forming side walls of the elevator car 6 are arranged between the ceiling 34 and the floor platform 36 of the elevator car frame 20. The side panels 38 may be attached to the ceiling 34 and/or the floor platform 36 of the elevator car frame 20. At least some of the side panels 38 in particular may by suspended at the ceiling 34.

FIG. 11 further depicts an elevator car door 12 and an elevator car door mechanism 50 provided at a front side of the elevator car 6 facing the landings 11, which are not shown in FIG. 11.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 driving member
4 hoistway
5 drive unit
6 elevator car
7a landing control panel
7b elevator car control panel
8 landing
10 service door
11 landing door
12 elevator car door
14 car guide member
15 counterweight guide member
19 counterweight
20 elevator car frame
22 support frame
24 upright
24a upper portion of the upright
24b lower portion of the upright
24c middle portion of the upright
25 functional component
26 upper support bar
28 lower support bar
30 fixing portion
32 driving member guide elements
34 ceiling
34a stationary portion of the ceiling
34b movable portions of the ceiling
35 hinge
36 floor platform
36a stationary portion of the floor platform
36b movable portion of the floor platform
38 side panel
40 support element
42 support rod
44 elastic buffer
46a, 46b rim
47 fixing mechanism
48a, 48b opening
49 fixing element
50 door mechanism

What is claimed is:

1. Foldable elevator car frame (20) comprising:
a ceiling (34), a floor platform (36) and at least one upright (24) extending between the floor platform (36) and the ceiling (34); and
at least one hinge (35) allowing at least a movable portion (36b) of the floor platform (36) and/or a movable portion (34b) of the ceiling (34) to pivot with respect to the at least one upright (24) between a folded transportation configuration and an extended operational configuration.

2. Foldable elevator car frame (20) according to claim 1, wherein the at least one movable portion (36b) of the floor platform (36) and/or the at least one movable portion (34b) of the ceiling (34) is pivotable around a respective axis which is oriented orthogonally to the at least one upright (24).

3. Foldable elevator car frame (20) according to claim 2, further comprising at least one fixing mechanism (48) configured for fixing at least one of the movable portions (34b, 36b) in the folded transportation configuration and/or in the extended operational configuration.

4. Foldable elevator car frame (20) according to claim 3, wherein the at least one fixing mechanism (48) includes at least one of a bolt or screw (49) and a hole (48a, 48b).

5. Foldable elevator car frame (20) according to claim 1, wherein the the ceiling (34) and/or floor platform (36) comprises a stationary portion (34a, 36a), which is rigidly connected to the at least one upright (24); and at least one movable portion (34b, 36b), which is pivotably connected to the stationary portion (34a, 36a) by the at least one hinge (35).

6. Foldable elevator car frame (20) according to claim 1, further comprising at least one side panel (38), which is pivotably mounted to the at least one upright (24).

7. Foldable elevator car frame (20) according to claim 6, wherein the at least one side panel (38) is pivotable around an axis which is oriented parallel to the at least one upright (24).

8. Foldable elevator car frame (20) according to claim 1, wherein the at least one upright (24) comprises:
an upper portion (24a) pivotably connected to the ceiling (34);
a lower portion (24b) pivotably connected to the floor platform (36); and
a middle portion (24c) pivotably connected to the upper and lower portions (24a, 24b), respectively,
so that the at least one upright (24) is foldable between an extended operational configuration, in which the upper portion (24a), the middle portion (24c), and the lower portion (24b) extend linearly along a common axis; and a folded transportation configuration, in which the upper and lower portions are (24a, 24b) oriented in an inclined configuration with respect to the middle portion (24c).

9. Foldable elevator car frame (20) according to claim 8, wherein at least one of the upper and lower portions (24a, 24b) of at least one of the uprights (24) is configured for supporting at least one functional component (25), such as a safety, at least one guiding element, and/or at least one sensor, in particular a sensor configured for detecting the position, the velocity and/or the acceleration of the elevator car frame (20).

10. Foldable elevator car frame (20) according to claim 1, further comprising at least one fixing portion (30), which is configured for fixing a driving member (3) to the elevator car frame (20), wherein the at least one fixing portion (30) in particular supports at least one driving member guide element (32), which is configured for guiding a driving member (3) supporting the elevator car frame (20).

11. Foldable elevator car frame (20) according to claim 10 wherein the at least one fixing portion (30) and/or the at least one driving member guide element (32) is arranged above the ceiling (34) and/or below the floor platform (36) of the elevator car frame (20).

12. Elevator car (6) comprising a foldable elevator car frame (20) according to claim 1 and at least one side panel (38) extending between the ceiling (34) and the floor platform (36) respectively arranged in the extended operational configurations.

13. Elevator system comprising at least one hoistway extending between a plurality of landings (8), and at least one elevator car (6) according to claim 12 which is movably suspended in the at least one hoistway (4) in a configuration allowing the elevator car (6) to move along the hoistway (4) between the plurality of landings (8).

14. Method of installing a foldable elevator car frame (20) according to claim 1 in a hoistway (4) of an elevator system (2), the method comprising:
arranging the foldable elevator car frame (20), in which the movable portions (34b, 36b) are arranged in their respective folded transportation configurations, within the hoistway (4);
unfolding the movable portions (34b, 36b) into their extended operational configurations; and
fixing the movable portions (34b, 36b) in their respective extended operational configurations.

15. Method according to claim 14, wherein the foldable elevator car frame (20) is a foldable elevator car frame (20), and the method includes unfolding the at least one upright (24) into an unfolded position in which it extends orthogonally to the floor platform (36) and orthogonally to the ceiling (34).
